(19) United States
(12) Patent Application Publication
(10) Pub. No.: US 2007/0038577 A1
(43) Pub. Date: Feb. 15, 2007

(54) Method of purchasing digitally encoded music, audiobooks, and video by one party for subsequent delivery to a third party

(76) Inventors: Gerald C. Werner, Buda, TX (US); Gerald L. Lozano, Buda, TX (US)

Correspondence Address: Gerald C. Werner, 759 E. Overlook Mountain, Buda, TX, 78610, US

(21) Appl. No.: 11/504,127

(22) Filed: Aug. 15, 2006

Related U.S. Application Data
(60) Provisional application No. 60/708,161, filed on Aug. 15, 2005.

(51) Int. Cl. G06Q 99/00

(52) U.S. Cl. 705/59

(57) ABSTRACT

A method is described to legally purchase digitally encoded music, audiobooks, and video for direct electronic transmission to a designated recipient to ensure that the designated recipient receives full rights to use the content. The rights conveyed to the recipient are similar or identical to the rights that would have been available to the recipient had he or she purchased the work directly from the owner of those rights.

### CROSS-REFERENCE TO RELATED APPLICATIONS

This application claims the benefit of U.S. Provisional Application Ser. No. 60/708,161, filed on Aug. 15, 2005, which is herein incorporated by reference for all intents and purposes.

### BACKGROUND OF THE INVENTION

1. Field of the Invention

The present invention relates to a method of purchasing digitally encoded music, audiobooks, and video by one party for subsequent delivery to a third party.

2. Description of the Related Art

The commercial sales of digitally encoded music, audiobooks, and video for delivery via the Internet requires the seller to convey “usage rights” to the ultimate user of that content. Those usage rights are ultimately conveyed from the copyright holders of those works (via the seller) to that user. The copyrights to these types of works are typically much more complicated than other types of digital content (e.g., software programs, online books, or photographs), because different parties can own different parts of the copyrighted material. The many different potential kinds of copyright holders for a particular work include Copyright of the Composition, Copyright of the Recording, and Mechanical Copyright. For Copyright of the Composition, the composer or music publisher or performing rights organization (e.g., ASCAP) may own the copyright to the composition (encompassing the words and music). For Copyright of the Recording, the original composer/performer or record label may own the particular recording of that work. A Mechanical Copyright is a right granted to a record company from the music publisher or its agent, granting the record company the right to record and release a specific composition at an agreed upon fee per unit manufactured and sold.

These rights were originally devised and have mostly evolved when information and entertainment works were largely sold on physical media, such as LP records, CDs, or videotapes. For such media, it was and is common for someone to purchase a creative work (music album or movie on DVD, for example) as a gift for a third party recipient, much as a husband might send flowers to his wife on their anniversary. Unfortunately, the digital distribution of these same works over the Internet have been much more limited than distribution of the physical media, so that online vendors (such as buy.com and amazon.com) that routinely allow buyers to send gifts to third parties have specifically chosen not to do so for audio and visual information and entertainment products such as digitally encoded music, audiobooks,and video works.

Some experts in the field are suggesting that the limitations to the distribution of digital works via the Internet is due, at least in part, to the complexity of the copyright process itself for these works. Professor Lydia Pallas Loren of the Northwestern School of Law of Lewis and Clark College, for example, makes the following conclusion in her widely referenced paper in the Spring 2003 issue of Case Western Law Review entitled “Untangling the Web of Music Copyrights.” The layering of copyright ownership interests and the complexity of copyright law, particularly as it applies to music, has played a major role in the inability of the industry to respond to the changing nature of the ways in which digital works can be distributed and otherwise exploited.

In order to sell these music, audiobook, and video products for online distribution, the vendor must first obtain agreements from all the relevant copyright holders as to the usage rights that the vendor will convey to whomever will typically be using (or playing) those works. Traditionally, part of the seller's agreement with the copyright holders has required that prior to the sale of digitally encoded music, audiobook, or video products, the seller must obtain a legally accepted consent from the buyer that acknowledges they buyer's sole usage rights to the acquired product. This usage rights agreement expressly prohibits the buyer from transferring his or her ownership rights to a subsequent recipient (e.g., resale). It also informs the buyer that the purchased work is protected by various copyrights. Both the usage rights agreement and the original copyrights of the work are violated when the digital file is freely shared (e.g., emailed in an attachment to others) or posted on peer-to-peer or other networks.

The whole issue of copyrights and usage agreements is very critical to the commercial success of digital music, audiobook, and video products. Unlike older analog entertainment products (such as phonographic records), digital information/entertainment files can be repeatedly duplicated with no loss of audio or video quality. Artists and the recording industry alike are rightfully concerned about the unauthorized copying and distribution of these files without compensation to the copyright holders, through peer-to-peer file transfer schemes that function similarly to the original Napster service. As a result of this theft of these digital music, audiobook, or video files, organizations representing the artists/music companies, such as the Recording Industry Association of America (RIAA) and Motion Picture Association of America (MPAA) have aggressively pursued legal action against both peer-to-peer technology companies as well as the individuals who participate in the crime. In order to protect itself, the recording industry in general has also negotiated very specific agreements relating to the distribution of lawfully purchased music, audiobook, and video products, so as to expressly prohibit purchasers from illegally sending such products to possible recipients.

The goal of usage agreements related to digitally encoded music, audiobooks, and video works is to restrict the legal rights to play those creative works to one individual, who cannot in turn legally transfer those rights to another individual. The traditional process, by its very nature of asking the buyer to agree to those usage rights, assumes that the buyer and recipient and, ultimately, user of the digital work are one and the same individual.

Since the traditional process of selling and distributing these works over the Internet has required the buyer to agree to those usage rights before he or she could download those works—and the usage rights virtually always prohibited the buyer from transferring those rights to a third party—the buyer could not therefore send those works over the Internet to third parties. Further, the aggressive legal pursuit of individuals who violate those usage rights by powerful industry organizations (e.g., the RIAA), combined with the complexity of modifying those usage rights provided the buyer due to what Prof. Loren calls the “layering of copyright ownership interests and the complexity of copyright law” as well as “traditional thinking” (where the buyer, recipient and user are assumed to be one and the same), have caused conventional online vendors, such as buy.com and amazon.com, to specifically avoid distributing these digital works to third parties.

There currently exist numerous mechanisms for the storage and transmittal of digitally encoded music, audiobook, and video content. For digital audio and audiobooks, these mechanisms include, but are not limited to, file formats such as MP3, WMA, RealAudio, QuickTime, and eReader. MPEG-1 Audio Layer 3 (MP3) is a popular format for the exchange of music across the Internet. A limitation of this format is that it lacks the ability to transfer or enforce copyright licenses. Variants of this format are used by companies such as Audible.com to convey and enforce licenses. WMA is a format from Microsoft for digital audio. It claims superior compression over MP3 without audio quality loss. Real Networks, Inc. currently supports the popular format of RealAudio for digital music, audio, and video. QuickTime is the format from Apple Computers, Inc., which supports digital music, audio, and video and is available on numerous platforms such as Apple, Windows, and Linux. The eReader format is a proprietary format that can be used to play and read books on handheld devices such as Palm, Windows-CE-based products and enhanced cell phones.

For digital video, the mechanisms include AVI, WMV, and ASF, among others. The AVI format compresses files to a very small size while retaining excellent quality. This format is typically used on files that will be stored on the computer or another hard or flash drive (USB Drives or HDDs). The WMV (Windows Media Video) is a common file format for videos that Microsoft recommends. The format has mediocre quality and compression, and often includes DRM (Digital Rights Management) coding. The Advanced Systems Format (ASF) is Microsoft's proprietary digital audio/digital video container format, especially meant for streaming video. The most common filetypes contained within an ASF file are Windows Media Audio (WMA) and Windows Media Video (WMV).

Currently, these file formats are used to contain digital representations of the content. These files can be purchased by an individual and the right to use the digitally encoded content within the file is restricted to use by that individual purchaser. These rights obtained by the purchaser do not generally allow the purchaser to either transmit or transfer the rights to a third party.

Most importantly, at the time of our provisional patent application (Aug. 15, 2005) there currently was no provision for a purchaser to secure relevant rights for a third party such as a gift recipient. Therefore, there was no legal vendor mechanism (e.g., business or web site) that permitted the purchase of digitally encoded music, audiobook, and video content that could be legally accessed by a third party such as a gift recipient.

As can be appreciated by those skilled in the art, it would be advantageous to provide a method of purchasing for a gift recipient digitally encoded music, audiobook, and video content that directs authorized delivery and subsequent use to the gift recipient.

### BRIEF DESCRIPTION OF THE DRAWINGS

The benefits, features, and advantages of the present invention will become better understood with regard to the following description and accompanying drawings where:

FIG. 1 is a flowchart diagram that illustrates the steps that the Vendor goes through to develop the Terms & Conditions (and especially the usage rights) that will be offered to the recipients. Note that while these figures all refer to “songs” or “music,” they would also apply to digitally encoded audiobooks and video works;

FIG. 2 is a flowchart diagram that illustrates the process that an online vendor would use to both sell digitally encoded music via their own website and deliver those works to third-party recipients over the Internet. Note that FIGS. 2, 3, and 4 all incorporate FIG. 5, which describes the common “back end” song delivery process resulting in the delivery to the recipient;

FIG. 3 is a flowchart diagram that illustrates the process that an Affiliate of the Vendor would use to sell digitally encoded music via the Affiliate's own website (or MySpace website), working in conjunction with the Vendor's own “Purchase and Delivery Engine” and the song delivery process to authorized recipients described in FIG. 5;

FIG. 4 is a flowchart diagram that illustrates the process used when a customer purchases a gift card that enables authorized recipients to download specific song(s) over the Internet;

FIG. 5 is a flowchart diagram that describes the common “back-end” or delivery process to authorized recipients that is common to the three different purchasing schemes described in FIGS. 2, 3, and 4 above; and

FIG. 6 is a mockup of a gift card that would enable an authorized recipient to download via the Internet specific songs that have been pre-selected by the gift card's purchaser. Such a card might be bought by the purchaser at a retail outlet like BestBuy or Wal-Mart, and then given to the recipient as a gift.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

This invention relates to a method of purchasing digitally encoded music, audiobooks, and video content with delivery to a designated recipient, and more particularly to conveying to the recipient the usage rights that would have been acquired had the recipient purchased the digital content his/herself. This method recognizes the fact that the purchaser and recipient (user) of the digital work are not (necessarily) one and the same individual. By considering these individuals as separate and distinct, the method supports a fully legal way for third-party recipients to receive digital works as gifts over the Internet.

This method does not require a pre-existing relationship between the purchaser and vendor, recipient and vendor, or the purchaser and the recipient.

This method directly addresses the concerns of the recording industry about the unauthorized copying and transmission of commercial music, audiobook, and video products, while providing a straightforward, convenient, and fully legal way for purchasers to send such products as gifts to their intended recipients.

The method allows the transport of digitally encoded music, audiobook, and video content from an authorized source (e.g., a vendor who has obtained legally acceptable consent to sell those works from the copyright holders) to a party or parties designated by a purchaser. An example of a method according to an embodiment of the present invention includes the following. An individual goes to an authorized source of digitally encoded music, audiobook, or video content. The individual then purchases a specific selection, pays for the selection, and designates a recipient who will receive the selection. The designated recipient is notified that the selection purchased is waiting for their pickup and is provided with the instructions to download the digital files to their personal computer or other device. The designated recipient follows the provided instructions and downloads the music, audiobook, or video work in electronic format. To download these files, the designated recipient must agree to a set of Terms and Conditions, which include a usage rights agreement that is similar or identical to the agreements presented to current digitial product purchasers. This usage rights agreement will have been approved by the original copyright holders of the purchased work. In a more specific embodiment, the designated recipient has the same rights as if he/she were the original purchaser of the digitally encoded music, audiobook, or video content from the authorized source.

For the purposes of clarity and understanding by someone not intimately familiar with copyright laws that impact digitally encoded music, audiobooks, and video, here are further details of what is meant by “authorized source” and “authorized recipient”:

An “authorized source” of digitally encoded music, audiobook, or video content is a vendor who has obtained all the necessary “right to sell” agreements that allow that vendor to sell that copyrighted content to end-users. As mentioned above, these agreements are quite complex due to the number and nature of the original copyright that protect the work being sold. The “right to sell” agreements must satisfy, at a minimum, the owners of the sound recording and musical work copyright. In the case of musical works, a compulsory mechanical license must be obtained by the vendor prior to executing any sales.

“Authorized delivery” requires that the content be “delivered” from an authorized source and in addition requires that the recipient has agreed to the copyright and use terms required by the copyright owners (via the authorized source) before the recipient can download or otherwise access that content.

A system according to the embodiment of the present invention distinguishes between the purchaser of the work (say, digitally encoded music) and the recipient, by making sure that the recipient is fully authorized to download and use the work. Systems that marketed music over the Internet at the time of our submission of a Provisional Patent Application did not make that distinction, and instead assumed that the purchaser and recipient were one and the same, so that the purchaser had to agree to the Terms and Conditions, including the all-important “usage rules” that are ultimately controlled by the copyright holders.

This invented method provides a fully legal way that purchasers can buy digitally encoded music, audiobook, and video products for third-party recipients (typically gift recipients).

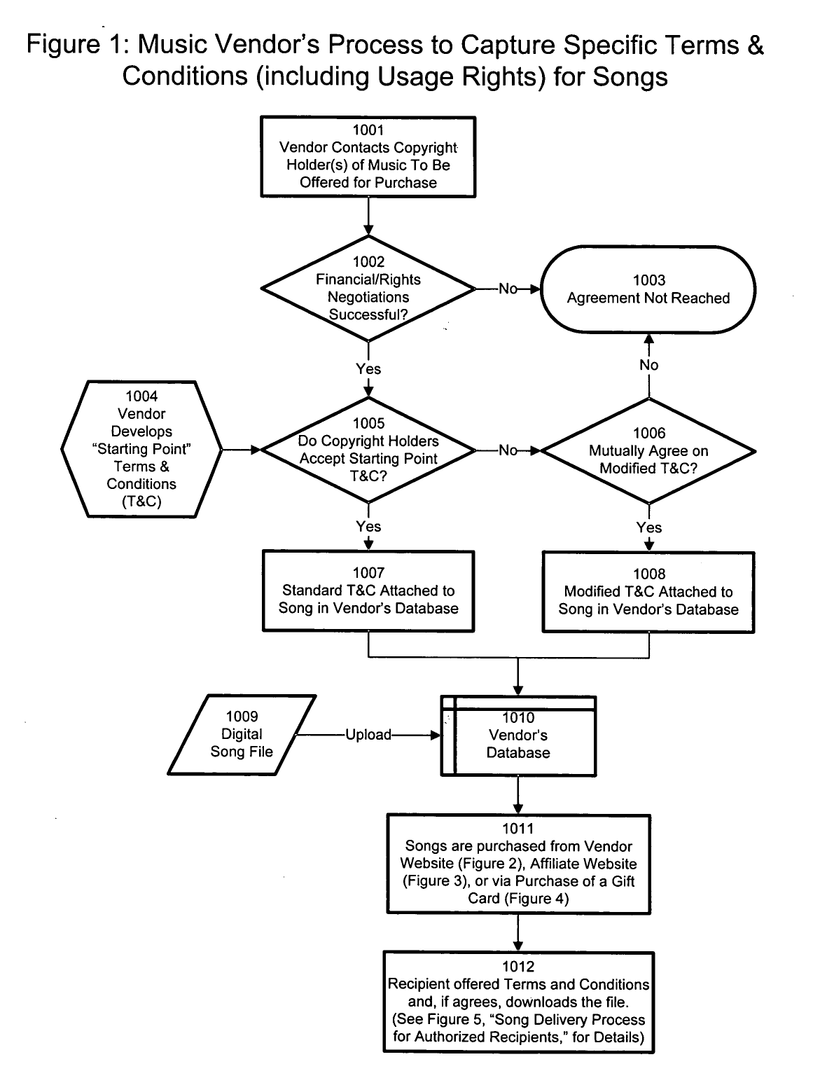

FIG. 1 shows one non-limiting process whereby a vendor of digitally encoded music, audiobooks, or video works captures the specific terms and conditions associated with each digital work sold that can be delivered to a third-party recipient. The figure and associated text description refer only to digital music, although a similar or identical process can be used for audiobooks and video works.

Initially, the vendor of the digital works contacts the holders of the various types of copyrights of the music that the vendor wishes to sell 1001. The vendor then negotiates both the financial terms and broad copyright issues with the copyright holders 1002. If no agreement is reached, the negotiations may terminate at this point 1003. If an agreement is reached, the vendor then works with the copyright holders to develop the terms and conditions, including usage rights, that will be offered to recipients. The vendor may have already developed “starting point terms and conditions” 1004 that it believes most copyright holders will agree to, and this agreement may be the starting point of these discussions with the copyright holders concerning these terms and conditions 1005. If the copyright holders accept this starting point terms and conditions 1005, then these conditions are associated with the particular song or songs in the vendor's database 1007. If the copyright holders do not accept the starting point terms and conditions, the copyright holders and vendor work to mutually agree on modified terms and conditions 1006. If they cannot agree on these modified terms and conditions the negotiations may terminate at this point 1003.

If the an agreement is reached on either using the standard terms and conditions 1007 or a modified terms and conditions 1008, the usage rights included in these terms will be similar or identical to the terms that the copyright holders typically offer to buyers of its digital music.

The agreed-upon terms and conditions are then included in the vendor's database 1010, and the digital song associated with those terms and conditions are also uploaded to the vendor's database 1010.

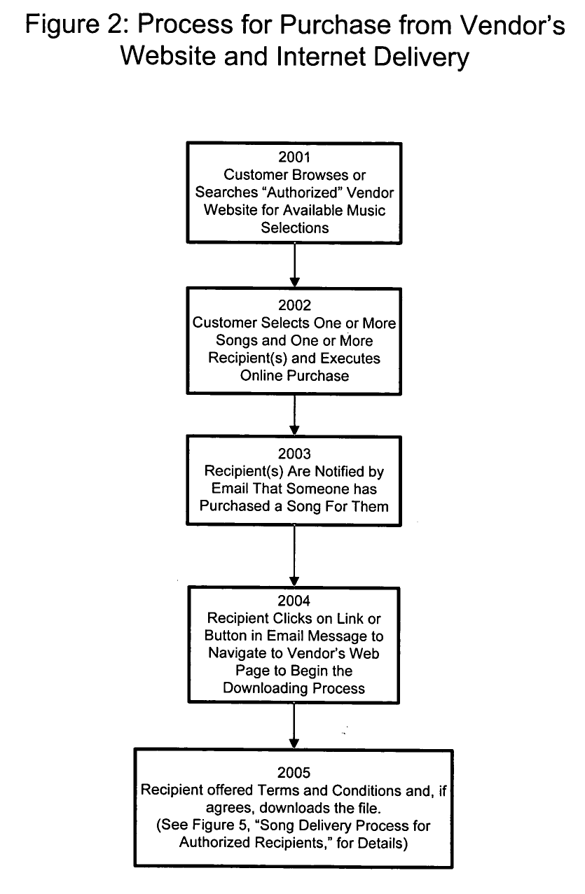

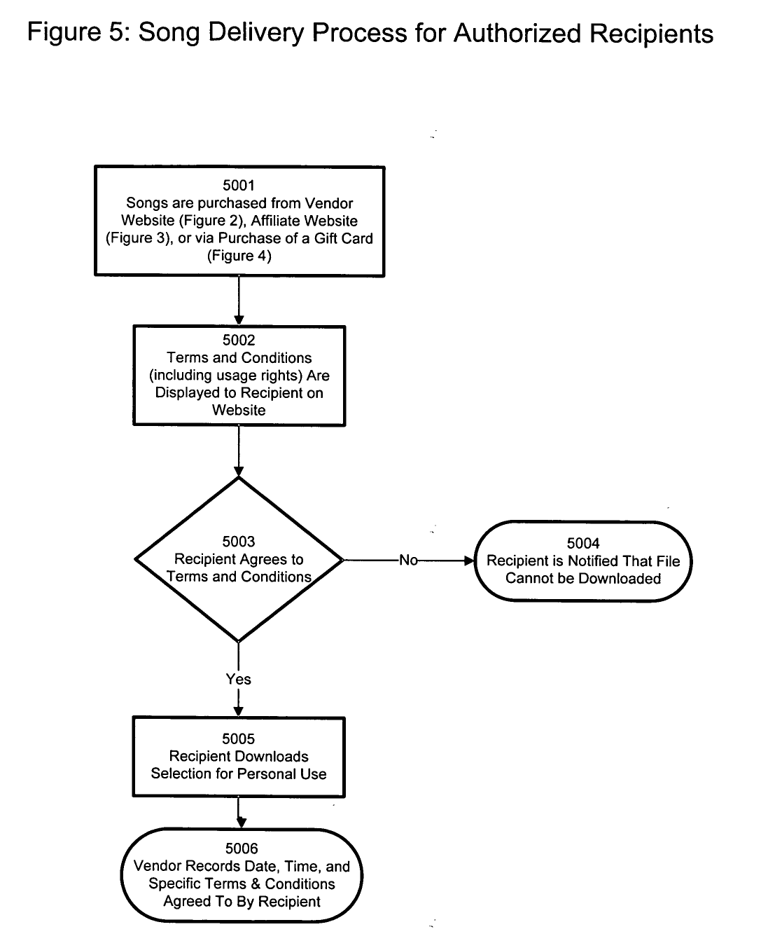

The digital music selections that have gone through this process are then available to be purchased by a purchaser 1011 as gifts to selected third-party recipients, who must go through a process 1012 to accept the agreed upon terms and conditions 1007 or 1008 before these recipients can retrieve these digital music selections. FIGS. 2, 3, and 4 describe in greater detail three different non-limiting ways the purchaser can purchase digital music intended for delivery to third-party recipients. FIG. 5 describes in greater detail the process that the recipients must go through to accept the terms and conditions and usage rules before they can then download the music selections.

FIG. 2 is a flowchart diagram that illustrates a non-limiting process that an online vendor would use to both sell digitally encoded music via their own website and deliver those works to third-party recipients over the Internet.

We will assume that digital music is the product that is purchased and delivered to a third party, although this same process would work equally well for digital audio books or digital video products:

The prospective customer visits the vendor's website that sells these digitally encoded music products, browses and/or searches 2001 for works that they like or think that the recipient(s) will like, selects the works that they want to send as gifts, specifies the gift recipient(s), and pays for these selection(s) 2002.

Each recipient(s) then receives an email notification that the purchaser has purchased these songs for them 2003, and a web link is provided for the recipient(s) to complete the process which permits the recipient to download the gift music files.

Once the recipient clicks on this web link 2004 for retrieving those music works, he or she is informed that they must agree to the copyright and use terms related to those works 2005. More detail of the song delivery process, including the recipient's agreement with the offered terms and conditions, is included in FIG. 5, which starts at the point where digital music is purchased by a purchaser from one of multiple non-limiting ways, the recipient has been given notice of that gift, and the recipient has navigated to the vendor's website to begin the download process 5001.

The recipient is then provided the terms and conditions associated with the specific digital music selections on the vendor's website 5002 and must agree to those terms before having the ability to download those selections 5003. Those terms typically specify where those works can be played (portable music device, computers, etc.) and how many times that music can be burned on audio CDs, if at all. These terms are similar or identical to terms offered to individuals who wish to purchase and download music for their own personal use. If the recipient declines to agree to those terms and conditions, he or she is notified that they will not be able to download those selections 5004.

Once the recipient legally accepts the terms of the delivery 5003 by clicking on a link or button signifying that acceptance, the music file(s) are then downloaded to the recipient's local computer 5005. The vendor then records in its database the date, time, and specific terms and agreements related to the recipient's retrieval of those specific digital music selections 5006.

The recipient can then play (on his or her computer or portable music device) or duplicate (on CD) those digitally encoded music files as allowed in the copyright/use terms that were specified and agreed to by the recipient.

Note that at no time does the purchaser take possession of the digitally encoded music, audiobook, or video works, nor does the purchaser own any usage rights to those works whatsoever. The purchaser does not personally transfer these works (or any of the associated rights) to the recipient—that is the role of the authorized source or vendor. In this transaction, from a licensing and use perspective, the recipient acts as though he or she had purchased the work from the vendor themselves. Therefore, the concerns widely expressed by both the music and movie industries about the unauthorized duplication and transmission of digital songs and videos, primarily due to peer-to-peer software networking schemes and products, do not apply in this process. A system according to an embodiment of the present invention is completely legal.

This implementation also permits the purchaser to select multiple songs and more than one recipient for a selected song 2002. For example, the purchaser can designate three specific recipients for one single selection, and two recipients for a second selection.

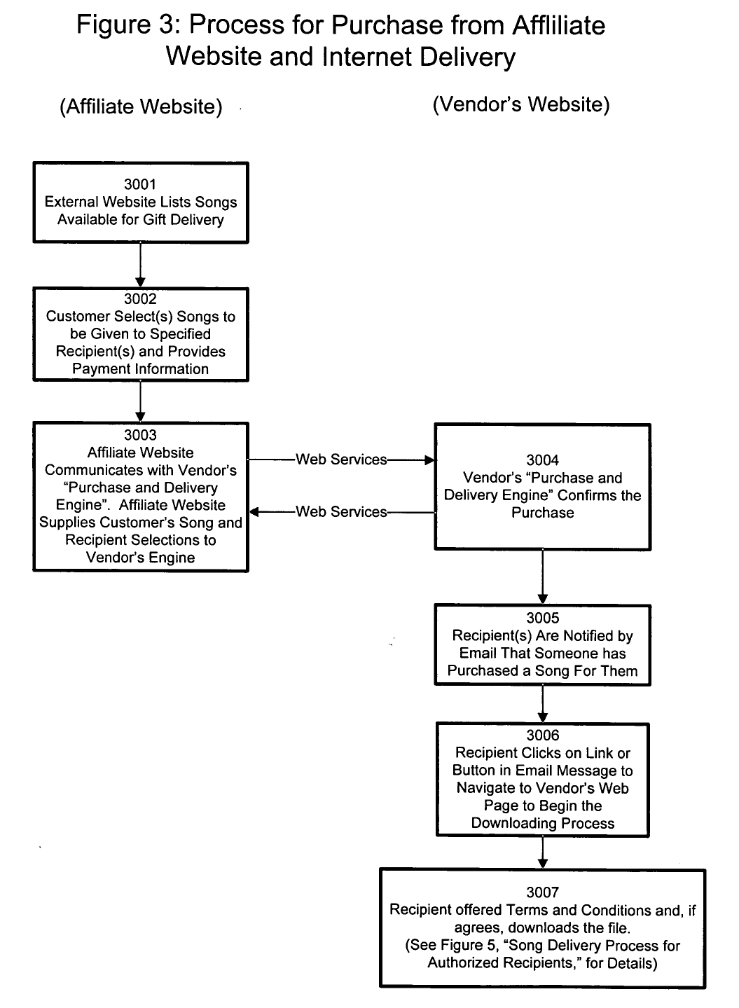

The invented method permits other useful non-limiting embodiments. FIG. 3 is a flowchart diagram that illustrates a non-limiting process that an Affiliate of the Vendor would use to sell digitally encoded music via the Affiliate's own website (or MySpace website), working in conjunction with the Vendor's own “Purchase and Delivery Engine” and the song delivery process to authorized recipients described in FIG. 5.

The process described in FIG. 3, like the one described in FIG. 2, enables the purchaser to purchase the digital music online, and then the selections are delivered online to the recipients after they agree to the copyright and usage rules. The primary difference with the process described in FIG. 2 is that the purchaser initially identifies music selections to be sent as gifts from websites that have established business relationships with the authorized vendor.

Those “affiliated sites” could include (non-limiting) an artist's or band's own website, an artist's or band's MySpace site, or an online flower retailer (e.g., 1-800-flowers.com) who would also like to be able to sell songs for special occasions. These are only three examples of possible affiliates, but many more embodiments are possible and supported by this method.

The non-limiting process described in FIG. 3 is as follows. Digital music selections that are available for gift delivery are shown on an affiliate's website 3001. A customer of that website then selects songs to be given to specified recipients and provides payment information 3002. The affiliate's website then communicates electronically with the vendor's purchase and delivery engine 3003 using web services or some other method. The vendor's purchase and delivery engine then confirms the purchase 3004 and then sends out notification to the recipients that someone has purchased digital music for them 3005.

Each recipient(s) then receives an email notification that the purchaser has purchased these songs for them 3005, and a web link is provided for the recipient(s) to complete the process which permits the recipient to download the gift music files 3006.

Once the recipient clicks on this web link 3006 for retrieving those music works, he or she is informed that they must agree to the copyright and use terms related to those works 3007. More detail of the song delivery process, including the recipient's agreement with the offered terms and conditions, is included in FIG. 5, which starts at the point where digital music is purchased by a purchaser from one of multiple non-limiting ways, the recipient has been given notice of that gift, and has navigated to the vendor's website to begin the download process 5001.

The recipient is then provided the terms and conditions associated with the specific digital music selections on the vendor's website 5002 and must agree to those terms before having the ability to download those selections 5003. Those terms typically specify where those works can be played (portable music device, computers, etc.) and how many times that music can be burned on audio CDs, if at all. These terms are similar or identical to terms offered to individuals who wish to purchase and download music for their own personal use. If the recipient declines to agree to those terms and conditions, he or she is notified that they will not be able to download those selections 5004.

Once the recipient legally accepts the terms of the delivery 5003 by clicking on a link or button signifying that acceptance, the music file(s) are then downloaded to the recipient's local computer 5005. The vendor then records in its database the date, time, and specific terms and agreements related to the recipient's retrieval of those specific digital music selections 5006.

The recipient can then play (on his or her computer or portable music device) or duplicate (on CD) those digitally encoded music files as allowed in the copyright/use terms that were specified and agreed to by the recipient.

Note that at no time does the purchaser take possession of the digitally encoded music, audiobook, or video works, nor does the purchaser own any usage rights to those works whatsoever. The purchaser does not personally transfer these works (or any of the associated rights) to the recipient—that is the role of the authorized source or vendor. In this transaction, from a licensing and use perspective, the recipient acts as though he or she had purchased the work from the vendor themselves. Therefore, the concerns widely expressed by both the music and movie industries about the unauthorized duplication and transmission of digital songs and videos, primarily due to peer-to-peer software networking schemes and products, do not apply in this process. A system according to an embodiment of the present invention is completely legal.

This process shown in FIG. 3 also permits the purchaser to select multiple songs and more than one recipient for a selected song 3002. For example, the purchaser can designate three specific recipients for one single selection, and two recipients for a second selection.

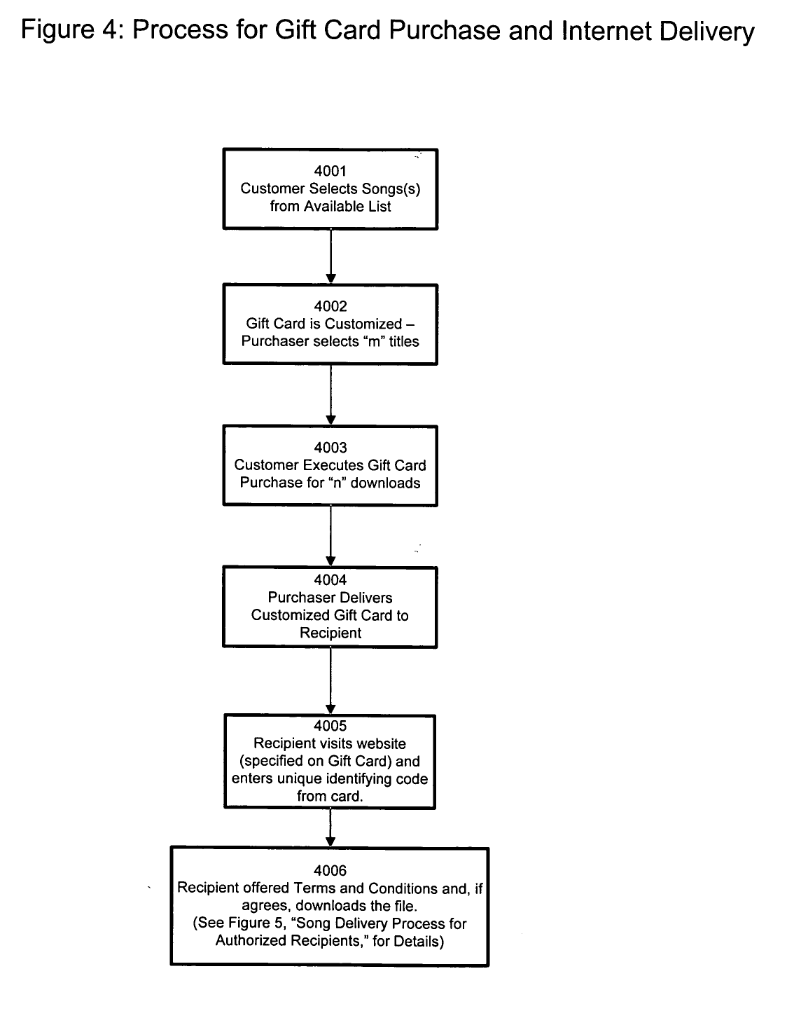

FIG. 4 is a flowchart diagram that illustrates a non-limiting process used when a customer purchases a gift card that enables authorized recipients to download specific songs over the Internet.

Note: The process for purchasing digitally encoded music is described, but the same process could also be used for digitally encoded audiobooks or video.

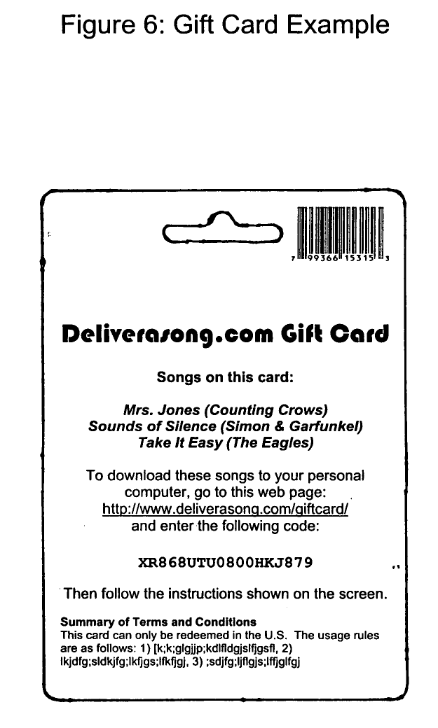

The process described in FIG. 4 differs from the previous two, as described in FIGS. 2 and 3, in that the “gift” that is purchased and subsequently given to the recipient is a gift card purchased, for example, from a retailer that sells such cards issued by an authorized source of digitally encoded music. That gift card enables a gift recipient to download one or more specific music selections (see the gift card example in FIG. 6). Importantly, the process for the “back end” or delivery of the gift music is identical to that described in FIGS. 2 and 3, and ensures that the recipient is legally authorized to download that music.

For FIG. 4, as in FIGS. 2 and 3, “vendor” refers to the company that has negotiated for and received written authorization from all the necessary copyright holders, and provides the website that handles recipient authorization and online delivery. “Retailer” refers to the company that has a business relationship with the vendor and sells gift cards to the public.

A customer of the retailer selects specific songs 4001 that can be downloaded by a third party recipient. The customer selects “m” songs 4002, and then executes the purchase of the gift card authorizing “n” downloads by the recipient 4003. For example, the purchaser might select 6 songs that he or she thinks that the recipient would enjoy, and then pay for the recipient to download any 3 of those songs. That way, the recipient would have a choice as to which 3 songs to download. That gift card could be pre-printed, or could be created “on-the-fly” by the customer selecting songs from an available list shown by the retailer in its store.

The customer gives that gift card to a friend or loved one as a gift 4004.

The gift card recipient reads the instructions on the gift card as to how to retrieve the gifted selections, as well as a summary of the “Terms and Conditions” that the recipient must agree to before he or she can download the gift selections. The gift card (example in FIG. 6) also includes a special code (number) that designates the specific pre-paid gift selections in the vendor's database. The gift-card recipient then follows the following process for downloading those selections via the Internet and accesses the web site URL listed on the gift card, which brings up a web page for gift card recipients. The gift-card recipient then enters the code number that was printed on the card 4005.

Once the recipient provides this code 4005, a new web page is displayed and he or she is informed that they must agree to the copyright and use terms related to those works 4006 in order to download them. More detail of the song delivery process, including the recipient's agreement with the offered terms and conditions, is included in FIG. 5, which starts at the point where digital music is purchased by a purchaser from one of multiple non-limiting ways, the recipient has been given notice of that gift, and has navigated to the vendor's website to begin the download process 5001.

The recipient is then provided the terms and conditions associated with the specific digital music selections on the vendor's website 5002 and must agree to those terms before having the ability to download those selections 5003. Those terms typically specify where those works can be played (portable music device, computers, etc.) and how many times that music can be burned on audio CDs, if at all. These terms are similar or identical to terms offered to individuals who wish to purchase and download music for their own personal use. If the recipient declines to agree to those terms and conditions, he or she is notified that they will not be able to download those selections 5004.

Once the recipient legally accepts the terms of the delivery 5003 by clicking on a link or button signifying that acceptance, the music file(s) are then downloaded to the recipient's local computer 5005. The vendor then records in its database the date, time, and specific terms and agreements related to the recipient's retrieval of those specific digital music selections 5006.

The recipient can then play (on his or her computer or portable music device) or duplicate (on CD) those digitally encoded music files as allowed in the copyright/use terms that were specified and agreed to by the recipient.

Note that at no time does the gift card purchaser take possession of the digitally encoded music, audiobook, or video works, nor does the purchaser own any usage rights to those works whatsoever. The purchaser does not personally transfer these works (or any of the associated rights) to the recipient—that is the role of the authorized source or vendor. In this transaction, from a licensing and use perspective, the recipient acts as though he or she had purchased the work from the vendor themselves. Therefore, the concerns widely expressed by both the music and movie industries about the unauthorized duplication and transmission of digital songs and videos, primarily due to peer-to-peer software networking schemes and products, do not apply in this process. A system according to an embodiment of the present invention is completely legal.

Note that this is only one possible embodiment of many involving gift cards. Other systems according to an embodiment of the present invention are possible where artists or bands create gift cards for promotional purposes that they give to prospective purchasers of their music, in order to let these possible new fans sample one or a few of their songs.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for carrying out the same purposes of the present invention without departing from the spirit and scope of the invention as defined by the appended claims.

What is claimed is:

1. A method of purchasing digital music, audiobooks, or video content by a purchaser from a vendor for delivery to a third party recipient, comprising:
selecting at least one digital title in which the title comprises at least one music, audiobook, or video work;
selecting at least one third party recipient;
purchasing each selected digital title by purchaser on behalf of each selected third party recipient;
notifying each selected third party recipient of said purchasing;
enabling access by each selected third party recipient to Terms and Conditions of usage of each selected digital title;
agreeing, by at least one selected recipient, to the Terms and Conditions; and
enabling download of each selected digital title by each selected recipient who has agreed to the Terms and Conditions.

2. The method of claim 1, wherein said agreeing to the Terms and Conditions comprises granting equal rights as though purchased directly.

3. The method of claim 1, further comprising:
said selecting at least one digital title comprising selecting a plurality of digital titles;
said selecting at least one third party recipient comprises selecting a plurality of digital third party recipients; and
selecting a first subset of the plurality of digital titles for a first subset of the plurality of third party recipients and selecting a second subset of the plurality of digital titles for a second subset of the plurality of third party recipients.

4. The method of claim 1, further comprising
said selecting of a number of “m” multiple digital titles by the purchaser as recommended gifts for a third-party recipient
said purchasing of a number of “n” of download opportunities, equal to or less than “m,” to be offered to the recipient
said conveying the gift from the purchaser to the recipient
said downloading by the recipient, after agreeing to the terms and conditions, of up to “n” digital titles from the “m” selections identified by the purchaser.

5. The method of claim 1, further comprising
said capturing by the vendor of separate terms and conditions and usage rules from the copyright holders for individual digital titles
said offering of terms and conditions and usage rules to the recipient that are unique for each digital title
said agreeing by the recipient to these terms and conditions before downloading the digital titles
recording by the vendor of the specific terms and conditions and usage rules associated with each individual digital title download by the recipient

6. The method of claim 1, wherein the digital titles made available to the recipient can be downloaded in any available digital format or representation, including incorporating or not incorporating digital rights management.
